(19) United States
(12) Patent Application Publication
(10) Pub. No.: US 2003/0125086 A1
(43) Pub. Date: Jul. 3, 2003

(54) Transmitting and receiving apparatus

(75) Inventor: Kenichi Ito, Tokyo (JP)

Correspondence Address: FOLEY AND LARDNER, SUITE 500, 3000 K STREET NW, WASHINGTON, DC, 20007, US

(73) Assignee: NEC CORPORATION

(21) Appl. No.: 10/327,999

(22) Filed: Dec. 26, 2002

(30) Foreign Application Priority Data
Dec. 27, 2001 (JP) 2001-396841

(51) Int. Cl. H04B 1/38

(52) U.S. Cl. 455/560; 455/555

(57) ABSTRACT

A transmitting and receiving apparatus can correctly perform transmission and reception of data by quickly determining a signal level of a transmission and reception control signal during a period where a control line of a bus line is not driven. The apparatus includes a master device, slave devices and a bus line connecting the master device and the slave devices. The master device outputs address information identifying the slave device through the bus line. The slave device outputs a reception control signal of the level depending upon capability of data transmission/reception through a control line by driving the control line forming the bus line to the master device. The apparatus also includes level stabilizing signal generating means for outputting a level stabilizing signal to the control line, by driving the control line during a period where the slave device does not drive the control line.

### BACKGROUND OF THE INVENTION

1. Field of the Invention

The present invention relates to a transmitting and receiving apparatus. More particularly, the invention relates to a transmitting and receiving apparatus for transmitting and receiving data through a bus line.

2. Description of the Related Art

For example, in a WCDMA (Wideband Code Division Multiple Access) radio base station equipment, user data loaded on ATM (Asynchronous Transfer Mode) cells are transmitted and received between an ATM switching portion and each base band processing portion of a MODEM (modulator-demodulator) or the like.

Here, the ATM switching portion is constructed as UTOPIA (Universal Test and Operation PHY (Physical Layer Protocol) Interface for ATM) level 2 master device, for example. The base band processing portion is constructed as UTOPIA level 2 slave device. As shown in FIG. 5, such UTOPIA level 2 master device 14 of the radio base station equipment 12 (which will also be referred to as ATM device 14) is mounted on a master (mother) board 16. On the other hand, each UTOPIA level 2 slave device 18 (which will also be referred to as PHY device 18) is mounted on each slave (child) board 20. These boards are connected to a back board 22 in such a manner that the ATM device 14 and the PHY device 18 perform transmission and reception of data through a UTOPIA bus line 24 on the back board 22.

The UTOPIA bus line 24 is constructed with a bus line for transmitting data from the ATM device 14 to the PHY devices 18, a bus line for transmitting data from the PHY devices 18 to the ATM device 14, and control line and so forth. On the other hand, the UTOPIA bus line 24 is terminated by terminal circuits 26 having impedance about 50 Ω in order to prevent distortion of signal waveform and to lower noise.

FIG. 6 is a circuit diagram showing an ATM device 14 and a peripheral circuit associating with data transmission from the ATM device 14 to the PHY devices 18, and FIG. 7 is a timing chart showing operation of the case where data is transmitted from the ATM device 14 to the PHY devices 18. It should be noted that, in FIG. 6, a circuit associated with data reception in the ATM device 14 and a circuit on the PHY device side are eliminated from illustration. On the other hand, like elements to those illustrated on FIG. 5 are identified by like reference numerals.

As shown in FIG. 6, the ATM device 14 outputs a clock TxClk, an address data TxAddr, data TxData, a start-of-cell signal TxSOC and an enabling signal TxEnb. These data and signal are fed to corresponding signal line of the UTOPIA bus line 24 (in FIG. 5) on the back board 22 via a driver circuit 28 for the back board.

When the ATM device 14 transmits data to the PHY device 18, the PHY device 18 transmits a cell-available signal TxClav to the ATM device 14. The cell-available signal TxClav is received by a receiver circuit 30 for back board through the UTOPIA bus line 24 and is supplied to the ATM device 14.

Next, discussion will be given for the operation when the ATM device 14 feeds data to the PHY device 18 with reference to FIG. 7.

As shown in FIG. 7, the ATM device 14 alternately outputs an address data TxAddr (n, n+1, n+2, . . . ) for identifying the PHY devices 18 and an address data TxAddr (1Fh) having “1” at all bits per each period of the clock TxClk having constant period. In the shown example, the address data TxAddr (n, n+1, n+2 . . . ) are output in periods of the even number clocks TxClk, and the address data TxAddr (1Fh) are output in periods of the odd number clock TxClk.

In contrast to this, each PHY device 18 is responsive to the own address data TxAddr (n, n+1, n+2, . . . ) to output the cell-available signal TxClav in the period of the next clock TxClk. The cell-available signal TxClav is a signal indicative whether the corresponding PHY device 18 can receive data TxData or not. When data can be received, the PHY device 18 outputs HIGH level cell-available signal TxClav, and outputs LOW level cell-available signal TxClav otherwise, in the shown example.

Each PHY device 18 has transmission and reception control means (not shown) for outputting the cell-available signal TxClav. The transmission and reception control means outputs the foregoing cell-available signal TxClav depending upon whether the PHY device 18 can receive data or not. The cell-available signal TxClav is supplied to the ATM device 14 via the receiver circuit 30 for the back board through a predetermined control line 32 (in FIG. 6) forming the UTOPIA bus line 24 of the back board 22.

On the other hand, the transmission and reception control means has an output portion constructed with a try state buffer circuit. During a period, in which the address data TxAddr (n, n+1, n+2, . . . ) is output, namely the period of the even number clock TxClk, the impedance of the output portion becomes HIGH to interrupt driving of the control line 32. The period where the transmission and reception control means interrupts driving of the control line 32 is illustrated by broken line Hc in FIG. 7.

After outputting the address data TxAddr (n, n+1, n+2, . . . ), when the corresponding PHY device 18 outputs the HIGH level cell-available signal TxClav, the ATM device 14 transmits data TxData using the start-of-cell signal TxSOC and enabling signal TxEnb to the PHY device 18, as shown in FIG. 7. The start-of-cell signal TxSOC is a signal indicative of a period, in which data TxData is effective. On the other hand, the enabling signal TxEnb is a signal indicative of the position of the first data TxData.

The ATM device 14 outputs the LOW level start-of-cell signal TxSOC and outputs fifty-three data TxData consisted of five headers H1 to H5 and forty-eight payloads P1 to P48 during the period, in which the start-of-cell signal TxSOC is LOW level to a data transmitting bus line in sequential order through the driver circuit 28 for the back board. Then, upon outputting the first data TxData, the start-of-cell signal TxSOC is set HIGH level to notify the position of the leading end of data to the PHY device 18.

FIG. 8 is a circuit diagram showing the ATM device 14 and the peripheral circuit of the ATM device 14 associating with data reception from the PHY device 18, and FIG. 9 is a timing chart showing operation when the ATM device 14 receives data from the PHY device 18. It should be noted that circuits associating with data transmission in the ATM device 14 and the corresponding circuit on the PHY device 18 side are eliminated from illustration in FIG. 18. On the other hand, in FIG. 8, like elements to those in FIGS. 5 and 6 are identified by like reference numerals.

As shown in FIG. 8, the ATM device 14 outputs a clock RxClk, an address data RxAddr and an enabling signal ExEnb. These data and signal are output to a signal line corresponding to the UTOPIA bus line 24 on the back board 22 through the driver circuit 34 for the back board.

When the ATM device 14 receives data from the PHY device 18, the PHY device 18 transmits a data RxData, a start-of-cell signal RxSOC and a cell available signal RxClav. These data and signals are received by a receiver circuit 36 for the back board from the PHY device 18 through the UTOPIA bus line 24 and are supplied to the ATM device 14.

Next, discussion will be given for operation in the case where the ATM device 14 receives data from the PHY device 18 with reference to FIG. 9.

As shown in FIG. 9, the ATM device 14 alternately outputs an address data RxAddr (n, n+1, n+2, . . . ) for identifying the PHY devices 18 and an address data RxAddr (1Fh) having “1” at all bits per each period of the clock RxClk having constant period. In the shown example, the address data RxAddr (n, n+1, n+2 . . . ) are output in periods of the even number clocks RxClk, and the address data RxAddr (1Fh) are output in periodes of the odd number clock RxClk.

In contrast to this, each PHY device 18 is responsive to the own address data RxAddr (n, n+1, n+2, . . . ) to output the cell-available signal RxClav in the period of the next clock RxClk. The cell-available signal RxClav is a signal indicative whether the corresponding PHY device 18 can receive data RxData or not. When data can be received, the PHY device 18 outputs HIGH level cell-available signal RxClav, and outputs LOW level cell-available signal RxClav otherwise, in the shown example.

The transmission and reception control means of each PHY device 18 outputs the foregoing cell-available signal RxClav depending upon whether the PHY device 18 can receive data or not. The cell-available signal RxClav is supplied to the ATM device 14 via the receiver circuit 36 for the back board through a predetermined control line 32 forming the UTOPIA bus line 24 of the back board 22.

On the other hand, during a period, in which the address data RxAddr (n, n+1, n+2, . . . ) is output, namely the period of the even number clock RxClk, the transmission and reception control means makes the impedance of the output portion HIGH to interrupt driving of the control line 32. The period where the transmission and reception control means interrupts driving of the control line 32 is illustrated by broken line Hc in FIG. 9.

After outputting the address data RxAddr (n, n+1, n+2, . . . ), when the corresponding PHY device 18 outputs the HIGH level cell-available signal RxClav, the ATM device 14 receives data RxData from the PHY device 18 using the start-of-cell signal RxSOC and enabling signal RxEnb, as shown in FIG. 9. The enabling signal RxEnb is a signal indicative that data RxData can be received. On the other hand, the start-of-cell signal RxSOC is a signal indicative of a position of the first data RxData.

The ATM device 14 sets the enabling signal RxEnb at the LOW level for notifying that data can be received, to the PHY device 18. In response to this, the PHY device 18 outputs fifty-three data RxData consisted of five headers H1 to H5 and forty-eight payloads P1 to P48 to a data reception bus line of the UTOPIA bus line (in FIG. 5). Then, upon outputting the first data RxData, the PHY device 18 outputs the HIGH level start-of-cell signal RxSOC.

It should be noted that each PHY device 18 makes the impedance of the output of the driver circuit (not shown) of the data receiving bus line 38 HIGH during a period not outputting the data RxData (broken line Hd in FIG. 9) and makes the impedance of the output of the driver circuit (not shown) of the control line for the start-of-cell signal RxSOC, in order to commonly use the bus line 38 for data reception and the control line 40 for the start-of-cell signal RxSOC.

FIG. 10 is a waveform chart showing a cell available signal TxClav in the control line 32 of the UTOPIA bus line 24 (in FIG. 5). As set forth above, for example, when the ATM device 14 transmits the address data TxAddr in the period of the even number clock TxClk to the PHY device 18, the transmission and reception control means of the PHY device 18 drives the control line 32 of the UTOPIA bus line 24 in the period of the subsequent odd number clock TxClk to output the cell available signal TxClav variable of level depending whether data can be received or not, to the control line 32. Then, the transmission and reception control means makes the impedance of its output HIGH during the period of the even number clock TxClk so as not to drive the control line 32 of the UTOPIA bus line 24.

Accordingly, during the period of the odd number clock TxClk, a parasitic capacity relating to the control line 32 is charged by the transmission and reception control means. And during the period of the even number clock Tx clk, the charge accumulated in the parasitic capacity is gradually discharged through the terminal circuit 26 of the UTOPIA bus line 24. As a result, a waveform of the cell available signal TxClav on the control line 32 of the UTOPIA bus line 24 is gradually lowered with moderate gradient as shown in FIG. 10 during the period of the even number clock, when the cell-available signal TxClav is HIGH level during the period of the odd number clock TxClk.

Then, when cell-available signal RxClav having the waveform set forth above is input to the receiver circuit 30 for the back board, the receiver circuit 30 for the back board may cause malfunction due to difficulty in accurate judgment of the level of the cell available signal RxClav to result in difficulty in performing normal data transmission from the ATM device 14 to the PHY device 18. When the ATM device 14 receives the data from the PHY device 18, similar problem is encountered since the waveform of the cell available signal Rx Clav is varied with moderate gradient during the period of the even number clock RcClk.

### SUMMARY OF THE INVENTION

The present invention has been worked out in view of the drawbacks set forth above. It is therefore an object of the present invention to provide a transmitting and receiving apparatus which can correctly perform transmission and reception of data by quickly determining a signal level of a transmission and reception control signal during a period where a control line of a bus line is not driven.

According to the first aspect of the present invention, a transmitting and receiving apparatus comprises:

a master device transmitting data;

a plurality of slave devices receiving data from the master device; and

a bus line connecting the master device and the slave devices,

the master device outputting address information identifying the slave device to the slave devices through the bus line, the slave device corresponding to the address information outputting a reception control signal of the level depending upon capability of data reception through a control line by driving the control line forming the bus line to the master device,

level stabilizing signal generating means for outputting a level stabilizing signal to the control line, by driving the control line during a period where the slave device does not drive the control line.

According to the second aspect of the present invention, a transmitting and receiving apparatus comprising:

a master device receiving data;

a plurality of slave devices transmitting data to the master device; and

a bus line connecting the master device and the slave devices,

the master device outputting address information identifying the slave device to the slave devices through the bus line, the slave device corresponding to the address information outputting a transmission control signal of the level depending upon capability of data transmission through a control line by driving the control line forming the bus line to the master device,

level stabilizing signal generating means for outputting a level stabilizing signal to the control line, by driving the control line during a period where the slave device does not drive the control line.

In the preferred construction, the level stabilizing signal may be a signal sufficient for instantly discharging a charge accumulated in a parasitic capacity of the control line. The master device sequentially may output the address information of respective slave devices in synchronism of a clock signal, and the slave devices may output the transmission and/or reception control signal by driving the control line for a given period in synchronism with the clock signal. The level stabilizing signal generating means outputs the level stabilizing signal in synchronism with the clock signal. The level stabilizing signal generating means may output the level stabilizing signal immediately after termination of driving of the control line by the slave device. The bus line may be terminated by a termination circuit.

In the transmitting and receiving apparatus according to the present invention constructed as set forth above, the level stabilizing signal generating means outputs the level stabilizing signal to the control line by driving the control line during the period where the slave device does not drive the control line. By this, the control line is driven by the slave device, the charge accumulated in the parasitic capacity relating to the control line can be instantly and quickly discharged. After terminating driving of the control line by the slave device, the problem in that the signal waveform of the control line is gradually varied with moderate gradient, can be successfully solved. Therefore, it becomes possible to perform infallibly level judgment of the transmission and reception control signal to permit to constantly assure data transmission between the master device and the slave device.

### BRIEF DESCRIPTION OF THE DRAWINGS

The present invention will be understood more fully from the detailed description given hereinafter and from the accompanying drawings of the preferred embodiment of the present invention, which, however, should not be taken to be limitative to the invention, but are for explanation and understanding only.

In the drawings:

FIG. 1 is a circuit diagram showing one embodiment of a transmitting and receiving apparatus according to the present invention, particularly showing an ATM device and a peripheral circuit associated with data transmission from the ATM device to a PHY device;

FIG. 2 is a timing chart showing operation of the case where data is transmitted from the ATM device to the PHY device;

FIG. 3 is a circuit diagram showing second embodiment of a transmitting and receiving apparatus according to the present invention, particularly showing an ATM device and a peripheral circuit associated with reception of data from the PHY device by the ATM device;

FIG. 4 is a timing chart showing operation of the case where the ATM device receives data from the PHY device;

FIG. 5 is a schematic block diagram showing a radio base station equipment;

FIG. 6 is a circuit diagram showing the ATM device and a peripheral circuit associated with data transmission from the ATM device to the PHY device;

FIG. 7 is a timing chart showing operation of the case where data is transmitted from the ATM device to the PHY device;

FIG. 8 is a circuit diagram showing the ATM device and a peripheral circuit associated with reception of data from the PHY device by the ATM device;

FIG. 9 is a timing chart showing operation of the case where the ATM device receives data from the PHY device; and

FIG. 10 is a waveform chart showing a cell available signal TxClav on a control line of a UTOPIA bus line.

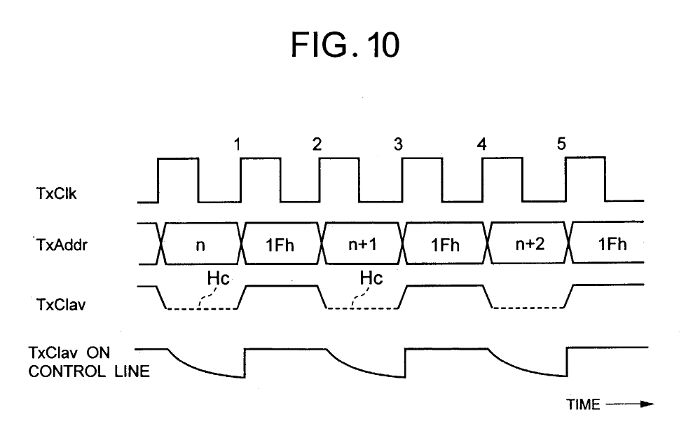

### DESCRIPTION OF THE PREFERRED EMBODIMENT

The present invention will be discussed hereinafter in detail in terms of the preferred embodiment of the present invention with reference to the accompanying drawings. In the following description, numerous specific details are set forth in order to provide a thorough understanding of the present invention. It will be obvious, however, to those skilled in the art that the present invention may be practiced without these specific details.

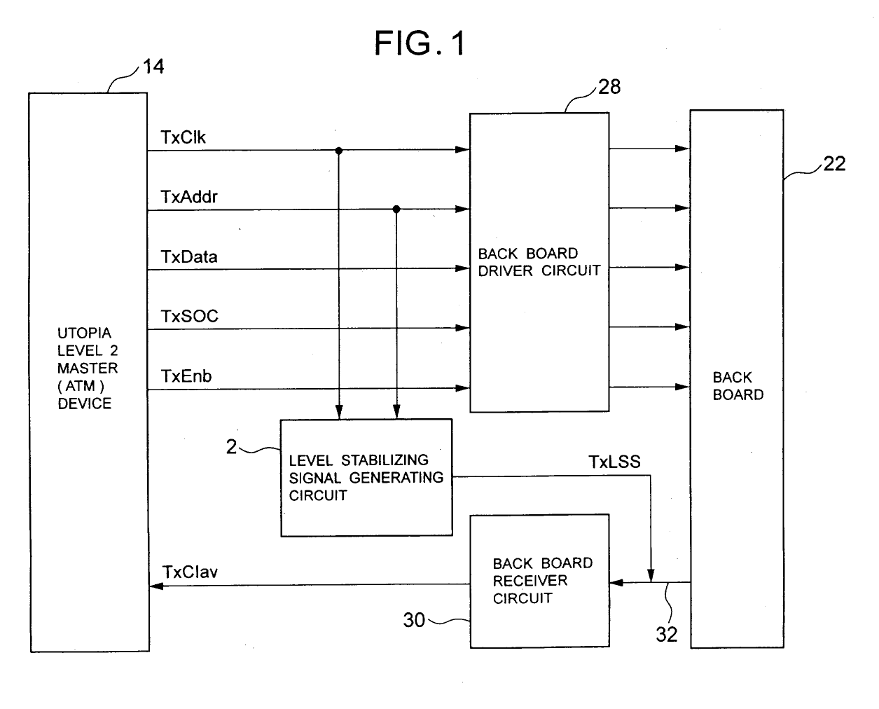

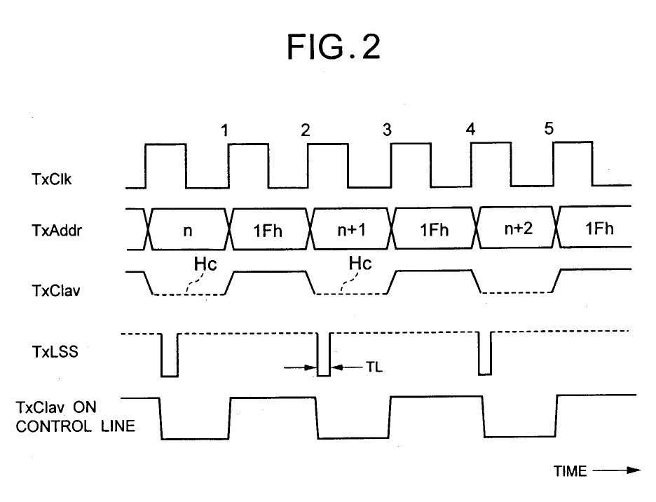

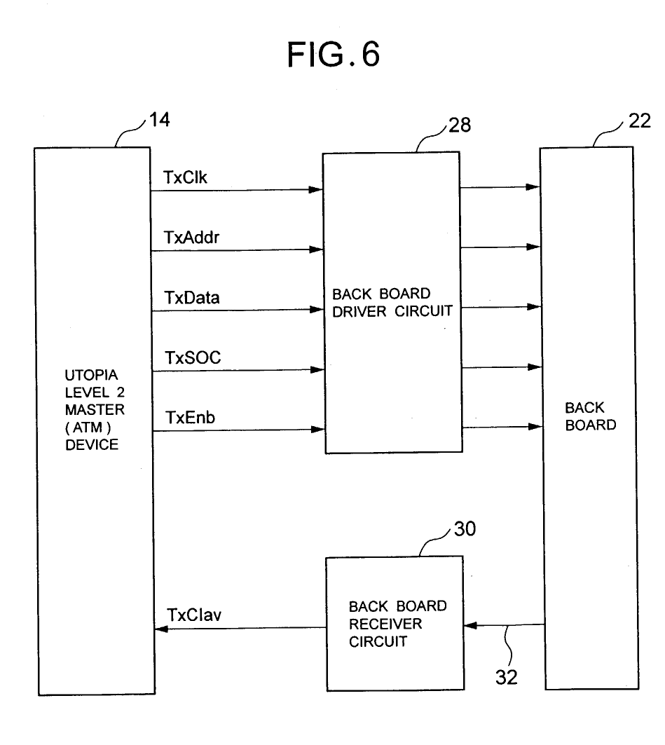

FIG. 1 is a circuit diagram showing one embodiment of a transmitting and receiving apparatus according to the present invention, particularly showing an ATM device and a peripheral circuit associated with data transmission from the ATM device to a PHY device, and FIG. 2 is a timing chart showing operation of the case where data is transmitted from the ATM device to the PHY device. It should be noted that FIG. 1 corresponds to FIG. 6 and like components corresponding those in FIG. 6 will be identified by like reference numerals, detailed description of which may be eliminated for avoiding redundant disclosure and keeping the disclosure simple enough to facilitate clear understanding of the present invention.

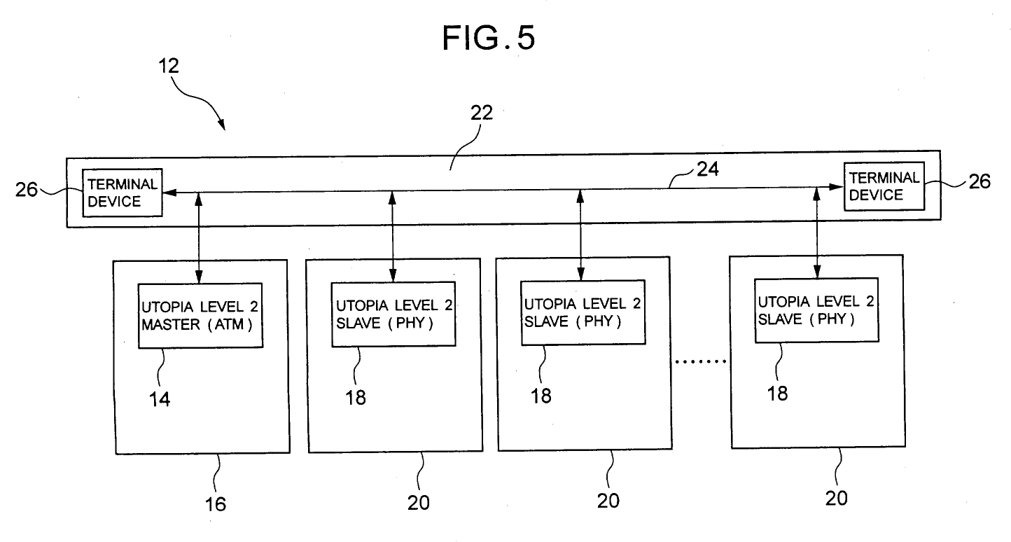

A circuit shown in FIG. 1 is differentiated from the circuit shown in FIG. 6 in that a level stabilizing signal generating circuit 2 is added. The level stabilizing signal generating circuit 2 outputs a level stabilizing signal to the control line 32 with driving the control line 32 during the period where the PHY device 18 shown in FIG. 5 (slave device relating to the present invention) does not drive the control line 32. An output portion of the level stabilizing signal generating circuit 2 is constructed with the try state buffer circuit (not shown). An output of the buffer circuit becomes high impedance state when the buffer circuit does not drive the control line 32 is not driven.

Hereinafter, discussion will be given for operation for stabilizing a signal level of the control line 32 by the level stabilizing signal generating circuit 2 with reference to FIG. 2 in addition to FIG. 1.

A basic operation relating to transmission of data from the ATM device 14 (master device in the present invention) to the PHY device 18 is similar to the case of FIG. 6. Namely, as shown in FIG. 2, the ATM device 14 alternately outputs an address data TxAddr (n, n+1, n+2, . . . ) for identifying the PHY devices 18 and an address data TxAddr (1Fh)having “1” at all bits per each period of the clock TxClk having constant period. In the shown embodiment, the address data TxAddr (n, n+1, n+2 . . . ) is output in the even number clock TxClk, and the address data TxAddr (1Fh) is output in the odd number clock TxClk.

In contrast to this, each PHY device 18 is responsive to the own address data TxAddr (n, n+1, n+2, . . . ) to output the cell-available signal TxClav in the period of the next clock TxClk by the transmission and reception control means (not shown). The cell-available signal TxClav is a signal indicative whether the corresponding PHY device 18 can receive data TxData or not. When the data can be received, the PHY device 18 outputs HIGH level cell-available signal TxClav, and outputs LOW level cell-available signal TxClav otherwise. The cell available signal TxClav is supplied to the ATM device 14 via the receiver circuit 30 for the back board through a control line 32 forming the UTOPIA bus line 24.

The transmission and reception control means operates in such a manner that during a period, in which the address data TxAddr (n, n+1, n+2, . . . ) is output, namely the period of the even number clock TxClk, the impedance of the output portion becomes HIGH to interrupt driving of the control line 32. The period where the transmission and reception control means interrupts driving of the control line 32 is illustrated by broken line Hc in FIG. 2.

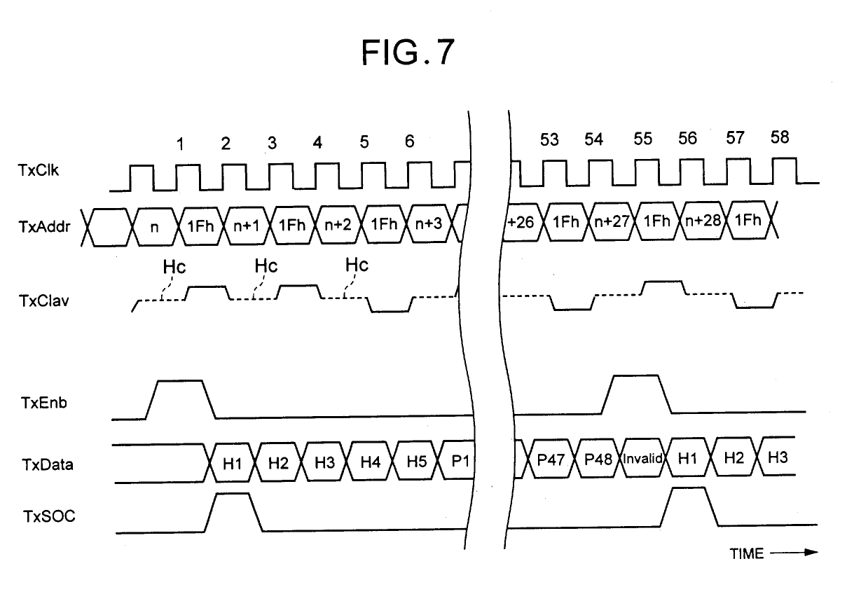

After outputting the address data TxAddr (n, n+1, n+2, . . . ), when the corresponding PHY device 18 outputs the HIGH level cell-available signal TxClav, the ATM device 14 transmits data TxData using the start-of-cell signal TxSOC and enabling signal TxEnb (FIG. 7).

Then, in the shown embodiment, the level stabilizing signal generating circuit 2 outputs a level stabilizing signal TxLSS heving a LOW level to the control line 32 by driving the control line 32 for a period TL (in FIG. 2) sufficiently shorter than the period of the clock TxClk in synchronism with rising edge of the clock TxClk immediately after ending of the period in which the ATM device 14 outputs the address data TxAddr (1Fh) The level stabilizing signal generating circuit 2 does not drive the control line 32 by setting the output thereof at HIGH impedance during periods other than the period TL. The period where the output of the level stabilizing signal generating circuit 2 is held HIGH impedance is shown by broken line in the level stabilizing signal TxLSS of FIG. 2.

As set forth above, as a result of outputting of the level stabilizing signal of the LOW level by the level stabilizing signal generating circuit 2 to the control line 32 by driving the control line 32 during the period TL, the charge accumulated in the parasitic capacity associating with the control line 32 as driven by the transmission and reception control means of the PHY device 18 during the period of the odd number clock TxClk is quickly discharged substantially at a moment during the period TL. Therefore, the cell available signal TxClav on the control line 32 immediately becomes LOW level as shown in FIG. 2. Therefore, in the shown embodiment, during the period where the control line 32 is not driven by the PHY device 18, the signal waveform of the control line 32 is never gradually vary with moderate gradient. Therefore, the receiver circuit 30 for the back board can make level judgment of the sell available signal TxClav without causing error to constantly assure data transmission between the ATM device 14 and the PHY device 18.

Next, discussion will be given for the second embodiment of the transmitting and receiving apparatus according to the present invention.

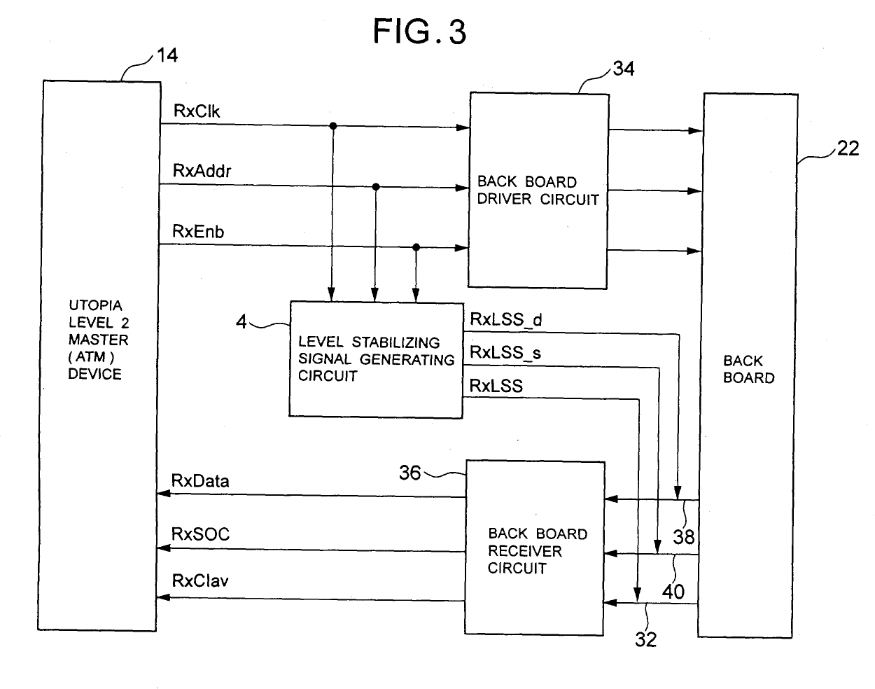

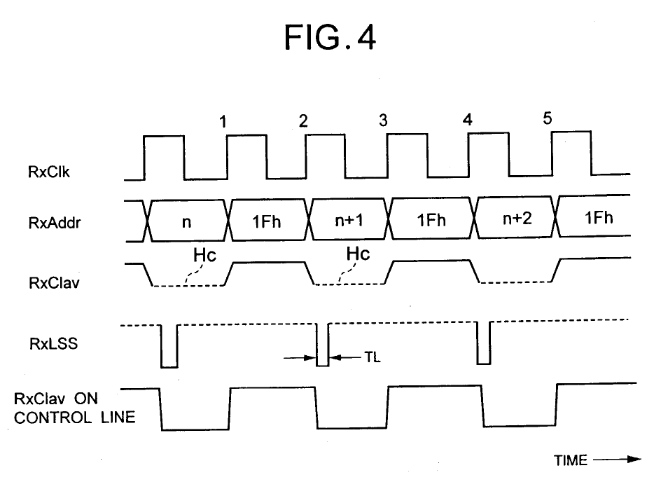

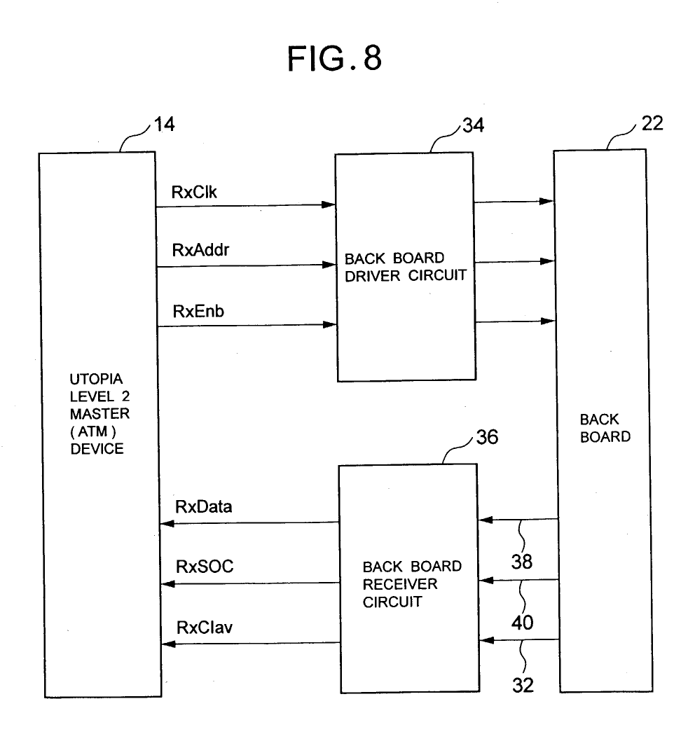

FIG. 3 is a circuit diagram showing second embodiment of a transmitting and receiving apparatus according to the present invention, particularly showing an ATM device and a peripheral circuit associated with reception of data from the PHY device by the ATM device, and FIG. 4 is a timing chart showing operation of the case where the ATM device receives data from the PHY device. It should be noted that FIG. 3 corresponds to FIG. 8 and like components corresponding those in FIG. 8 will be identified by like reference numerals, detailed description of which may be eliminated for avoiding redundant disclosure and keeping the disclosure simple enough to facilitate clear understanding of the present invention.

A circuit shown in FIG. 3 is differentiated from the circuit shown in FIG. 8 in that a level stabilizing signal generating circuit 4 is added. The level stabilizing signal generating circuit 4 outputs a level stabilizing signal to the control line 32 with driving the control line 32 during the period where the PHY device 18 shown in FIG. 5 (slave device relating to the present invention) does not drive the control line 32. An output portion of the level stabilizing signal generating circuit 4 is constructed with the try state buffer circuit (not shown). An output of the buffer circuit becomes high impedance state when the buffer circuit does not drive the control line 32.

Hereinafter, discussion will be given for operation for stabilizing a signal level of the control line 32 by the level stabilizing signal generating circuit 4 with reference to FIG. 4 in addition to FIG. 3.

A basic operation relating to transmission of data from the ATM device 14 (master device in the present invention) to the PHY device 18 is similar to the case of FIG. 16. Namely, the ATM device 14 alternately outputs an address data RxAddr (n, n+1, n+2, . . . ) for identifying the PHY devices 18 and an address data RxAddr (1Fh) having “1” at all bits per each period of the clock RxClk having constant period. In the shown embodiment, the address data RxAddr (n, n+1, n+2 . . . ) is output in the even number clock RxClk, and the address data RxAddr (1Fh) is output in the odd number clock RxClk.

In contrast to this, each PHY device 18 is responsive to the own address data RxAddr (n, n+1, n+2, . . . ) to output the cell-available signal RxClav in the period of the next clock RxClk. The cell-available signal RxClav is a signal indicative whether the corresponding PHY device 18 hold data RxData to be transmitted or not. When the data to be transmitted is holded, the PHY device 18 outputs HIGH level cell-available signal RxClav, and outputs LOW level cell-available signal RxClav otherwise.

Each PHY device 18 has the transmission and reception control means (not shown) for outputting the cell available signal RxClav. The transmission and reception control means outputs the cell available signal RxClav set forth above depending upon presence and absence of the transmission data. The cell available signal RxClav is supplied to the ATM device 14 via the receiver circuit 36 for the back board through the control line 32 forming the UTOPIA bus line 24. On the other hand, the transmission and reception control means stops driving of the control line 32 with setting its output at HIGH impedance during the period, in which the address data RxAddr (n, n+1, n+2, . . . ) is output, namely in the period of the even number clock RxClk.

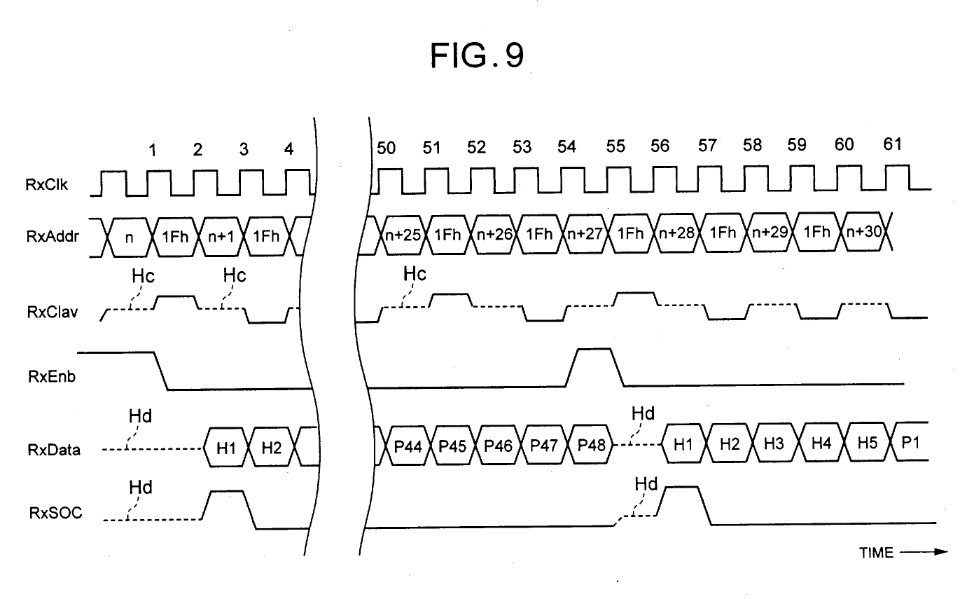

After outputting the address data RxAddr (n, n+1, n+2, . . . ), when the corresponding PHY device 18 outputs the HIGH level cell-available signal RxClav, the ATM device 14 receives data RxData using the enabling signal RxEnb and the start-of-cell signal RxSOC from the PHY device 18 (in FIG. 9).

Then, in the shown embodiment, the level stabilizing signal generating circuit 4 outputs a level stabilizing signal RxLSS having a LOW level to the control line 32 by driving the control line 32 for a period TL sufficiently shorter than the period of the clock RxClk in synchronism with rising edge of the clock RxClk immediately after ending of the period in which the ATM device 14 outputs the address data RxAddr (1Fh). The level stabilizing signal generating circuit 4 does not drive the control line 32 by setting the output thereof at HIGH impedance during periods other than the period TL. The period where the output of the level stabilizing signal generating circuit 4 is held HIGH impedance is shown by broken line in the level stabilizing signal RxLSS of FIG. 4.

As set forth above, as a result of outputting of the level stabilizing signal RxLSS of the LOW level by the level stabilizing signal generating circuit 4 to the control line 32 by driving the control line 32 during the period TL, the charge accumulated in the parasitic capacity associating with the control line 32 as driven by the transmission and reception control means of the PHY device 18 during the period of the odd number clock RxClk is quickly discharged substantially at a moment during the period TL. Therefore, in the shown embodiment, during the period where the control line 32 is not driven by the PHY device 18, the signal waveform of the control line 32 is never gradually vary with moderate gradient. As a result, the receiver circuit 36 for the back board can make level judgment of the sell available signal RxClav without causing error to constantly assure data transmission between the ATM device 14 and the PHY device 18.

On the other hand, in the shown embodiment, the level stabilizing signal generating circuit 4 drives respective of the bus line 38 for data reception and the control line 40 for the start-of-cell signal RxSOC at a timing of starting of the period where the PHY device 18 does not output the data RxData and the start-of-cell signal RxSOC to the bus line 38 for data reception, namely the period shown by broken line Hd in FIG. 9, to output the level stabilizing signal RxLSS_d and RxLSS_s similar to the level stabilizing signal RxLSS to the bus line 38 for data reception and the control line 40 for start-of-cell signal RxSOC.

Accordingly, at a timing starting the period where the bus line 38 for data reception and the control line 40 for start-of-cell signal RxSOC are not driven by the PHY device 18 (the period shown by the broken line Hd of FIG. 9), the charge accumulated in the parasitic capacity relating to these bus line and the control line is discharged. Thus, the signal level immediately becomes the LOW level similarly to the case of the control line 32. Therefore, in the shown embodiment, the receiver circuit 36 for the back board can perform level judgment without error in relation to the data RxData and start-of-cell signal RxSOC.

It should be noted that the level stabilizing signal generating circuit 4 specifies a timing of starting the period where the bus line 38 for data reception and so forth are not driven by a timing for varying the enabling signal RxEnb from the HIGH level to the Low level, and thus can output the level stabilizing signals Rx-LSS_d and RxLSS_s.

As discussed above, with the transmitting and receiving apparatus according to the present invention, the level stabilizing signal generating means outputs the level stabilizing signal to the control line by driving the control line during the period where the slave device does not drive the control line. By this, the charge accumulated in the parasitic capacity relating to the control line during the control line is driven by the slave device, can be quickly discharged. After terminating driving of the control line by the slave device, the problem in that the signal waveform of the control line is gradually varied with moderate gradient, can be successfully solved. Therefore, it becomes possible to perform infallibly level judgment of the transmission and reception control signal to permit to constantly assure data transmission between the master device and the slave device.

Although the present invention has been illustrated and described with respect to exemplary embodiment thereof, it should be understood by those skilled in the art that the foregoing and various other changes, omission and additions may be made therein and thereto, without departing from the spirit and scope of the present invention. Therefore, the present invention should not be understood as limited to the specific embodiment set out above but to include all possible embodiments which can be embodied within a scope encompassed and equivalent thereof with respect to the feature set out in the appended claims.

What is claimed is:

1. A transmitting and receiving apparatus comprising:
a master device transmitting data;
a plurality of slave devices receiving data from the master device; and
a bus line connecting the master device and the slave devices,
the master device outputting address information identifying the slave device to the slave devices through the bus line, the slave device corresponding to the address information outputting a reception control signal of the level depending upon capability of data reception through a control line by driving the control line forming the bus line to the master device,
level stabilizing signal generating means for outputting a level stabilizing signal to the control line, by driving the control line during a period where the slave device does not drive the control line.

2. A transmitting and receiving apparatus as set forth in claim 1, wherein the level stabilizing signal is a signal sufficient for instantly discharging a charge accumulated in a parasitic capacity of the control line.

3. A transmitting and receiving apparatus as set forth in claim 1, wherein the master device sequentially outputs the address information of respective slave devices in synchronism of a clock signal, and the slave device outputs the reception control signal by driving the control line for a given period in synchronism with the clock signal.

4. A transmitting and receiving apparatus as set forth in claim 3, wherein the level stabilizing signal generating means outputs the level stabilizing signal in synchronism with the clock signal.

5. A transmitting and receiving apparatus as set forth in claim 4, wherein the level stabilizing signal generating means outputs the level stabilizing signal immediately after termination of driving of the control line by the slave device.

6. A transmitting and receiving apparatus as set forth in claim 1, wherein the bus line is terminated by a termination circuit.

7. A transmitting and receiving apparatus comprising:
a master device receiving data;
a plurality of slave devices transmitting data to the master device; and
a bus line connecting the master device and the slave devices,
the master device outputting address information identifying the slave device to the slave devices through the bus line, the slave device corresponding to the address information outputting a transmission control signal of the level depending upon capability of data transmission through a control line by driving the control line forming the bus line to the master device,
level stabilizing signal generating means for outputting a level stabilizing signal to the control line, by driving the control line during a period where the slave device does not drive the control line.

8. A transmitting and receiving apparatus as set forth in claim 7, wherein the level stabilizing signal is a signal sufficient for instantly discharging a charge accumulated in a parasitic capacity of the control line.

9. A transmitting and receiving apparatus as set forth in claim 7, wherein the master device sequentially outputs the address information of respective slave devices in synchronism of a clock signal, and the slave device outputs the transmission control signal by driving the control line for a given period in synchronism with the clock signal.

10. A transmitting and receiving apparatus as set forth in claim 9, wherein the level stabilizing signal generating means outputs the level stabilizing signal in synchronism with the clock signal.

11. A transmitting and receiving apparatus as set forth in claim 10, wherein the level stabilizing signal generating means outputs the level stabilizing signal immediately after termination of driving of the control line by the slave device.

12. A transmitting and receiving apparatus as set forth in claim 7, wherein the bus line is terminated by a termination circuit.
